(19) United States
(12) Patent Application Publication
(10) Pub. No.: US 2013/0281171 A1
(43) Pub. Date: Oct. 24, 2013

(54) SLOT MACHINES WITH WAGER-PER-PLAY SKILL GAMES

(71) Applicants: William David Ramsour, Austin, TX (US); Brian Watkins, Austin, TX (US); Allison Pope, Austin, TX (US); Clint Owen, Austin, TX (US)

(72) Inventors: William David Ramsour, Austin, TX (US); Brian Watkins, Austin, TX (US); Allison Pope, Austin, TX (US); Clint Owen, Austin, TX (US)

(73) Assignee: Multimedia Games, Inc., Austin, TX (US)

(21) Appl. No.: 13/449,855

(22) Filed: Apr. 18, 2012

(51) Int. Cl. A63F 13/00

(52) U.S. Cl. 463/10

(57) ABSTRACT

Provided is a wager-per-play skill game in which the player's skill is used in selecting one of several random prize distributions or prize pools from which the player's award will be randomly selected. Wagers are preferably entered automatically for each skilled interaction the player makes in the game play area, allowing for continuous play in which the game state persists between wagers. In one version, there is no possibility of complete failure of the skill game, instead every move of the player is given an immediate skill rating or value. The immediate skill rating is used to select an associated prize distribution or prize pool from among multiple distributions or pools, which is then applied to randomly select a prize for the player's move.

### TECHNICAL FIELD OF THE INVENTION

The invention relates to gaming systems and gaming machines through which players may participate in wagering games involving skill. More particularly this invention relates to skill games in which player skill is part of the process determining wager results.

### BACKGROUND OF THE INVENTION

Various slot machine games have tried to incorporate games of skill in the context of a player wager to make the games more exciting and increase player engagement. However, the typical slot machine skill game suffers from a number of drawbacks. Many games include a skill game totally divorced from the presentation of the randomized slot machine game, almost as if it were tagged on as an afterthought. Still other skill games contrive arbitrary ways of introducing wagering into the skill game, such as a moving player avatar along a path in the game, and at certain points along the path a wager occurs. Other slot machine skill games award play in the skill game as part of the award for a slot win. Still others provide a game that appears to be a skill game, but the skill actually has little to no effect, known as “pseudo-skill” or “perceived skill.”

What is needed are more exciting techniques for integrating games of skill into slot machine games in order to increase player excitement and enjoyment.

### SUMMARY OF THE INVENTION

The present invention includes a highly entertaining method of conducting a game for one or more players. Provided is a wager-per-play skill game in which the player's skill is used in selecting one of several random prize pools from which the player's award will be drawn. In one version, there is no possibility of complete failure of the skill game, instead every move of the player is given a skill rating or value. They are then awarded a random prize drawn from a prize pool that corresponds to the skill rating of their move.

Another embodiment provides a gambling game containing a game board that the player interacts with during every play. Each play requires a wager, and has a set number of board interactions, one or more, with those interactions altering the layout of the board. Preferably, the wager input is automatically made based on a skill move the player makes in the game. The layout at any given time determines the range of moves and skill ratings available. In this game, and other suitable embodiments, there is a possible strategy in which the player intentionally makes a lower rated move to improve the state of the board for achieving high skill ratings on subsequent moves. The board layout may persist between player sessions.

This invention allows for providing a gambling game that incorporates player skill in an entertaining manner. Paytables of all prize pools can be structured to allow average players to earn enough to keep the game entertaining, and limit highly skilled players to earning below an acceptable maximum payout (most likely just below 100% return).

A preferred embodiment provides a matching game in which players are presented with a grid of coded objects. The code may be different colors, shapes, letters or other designations. Objects A and B are said to be in the same group if both objects match, and it is possible to trace a path from object A to object B by only passing over other objects that match A and B. The preferred game uses a path that only involves moving to adjacent objects in the vertical or horizontal directions. The player interacts with the board by selecting an object, which in turn identifies and selects all objects that are in the same group as the selected object. All objects in that group are then removed from the board. Objects above the now empty spaces move into the void created by the removed group, preferably by falling downward. Then, new objects are created to fill in when there is empty space at the top of the grid.

Players enter skilled game play moves in a game play area, which automatically places a wager. The wager may entitle the player to more than one move. In the board game version described above, each move eliminates a group of objects. The player is then awarded with a prize drawn from the prize pool that corresponds to the size of the group that they just eliminated. The larger the group, the greater the expected value of their prize. Part of the distribution of each prize pool may include bonus games. In one variation, certain valued prize distributions may guarantee particular bonus games.

Another version of the invention is a computer program stored on a non-transitory readable medium. The software version is, of course, typically designed to be executed by a gaming machine or networked gaming system. The software includes multiple portions of computer executable code referred to as program code. Gaming results are provided in response to a wager and displayed by display program code that generates the interactive game display employed in each particular embodiment.

Another version of the invention is a gaming system that includes one or more gaming servers, and a group of electronic gaming machines connected to the servers by a network. The various functionality described herein may be distributed between the electronic gaming machines and the gaming servers in any practically functional way. For example, the current preferred architecture is for the servers to determine all aspects of game logic, random number generation, and prize awards. The gaming machines provide functionality of interfacing with the player and animating the game results received from the server in an entertaining manner. However, other embodiments might use a thin client architecture in which the animation is also conducted by the server, and electronic gaming machines serve merely as a terminal to receive button or touch screen input from the player and to display graphics received from the server.

Different features may be included in different versions of the invention. These and other advantages and features of the invention will be apparent from the following description of the preferred embodiments, considered along with the accompanying drawings.

### BRIEF DESCRIPTION OF THE DRAWINGS

FIGS. 1A-1C are an example series of game screen diagrams according to one embodiment providing a skill game in which the player eliminates groups of matching gamepieces.

FIG. 2A is a flowchart showing an example game play process at a gaming machine that includes a wager-per-play skill symbol according to another embodiment.

FIG. 2B is a flowchart of a process for conducting a wager-per-play skill game according to the embodiment shown in FIGS. 1A-C.

FIG. 2C is a flowchart of a process for providing a wager-per-play skill game according to another embodiment.

FIG. 3A is a front perspective view of a gaming machine which may be used in a gaming system embodying the principles of the present invention.

FIG. 3B is a block diagram showing various electronic components of the gaming machine shown in FIG. 3A together with additional gaming system components.

FIG. 4A is a system block diagram of a gaming system according to one embodiment of the present invention.

FIG. 4B is a system block diagram of a gaming system according to another embodiment.

### DETAILED DESCRIPTION OF PREFERRED EMBODIMENTS

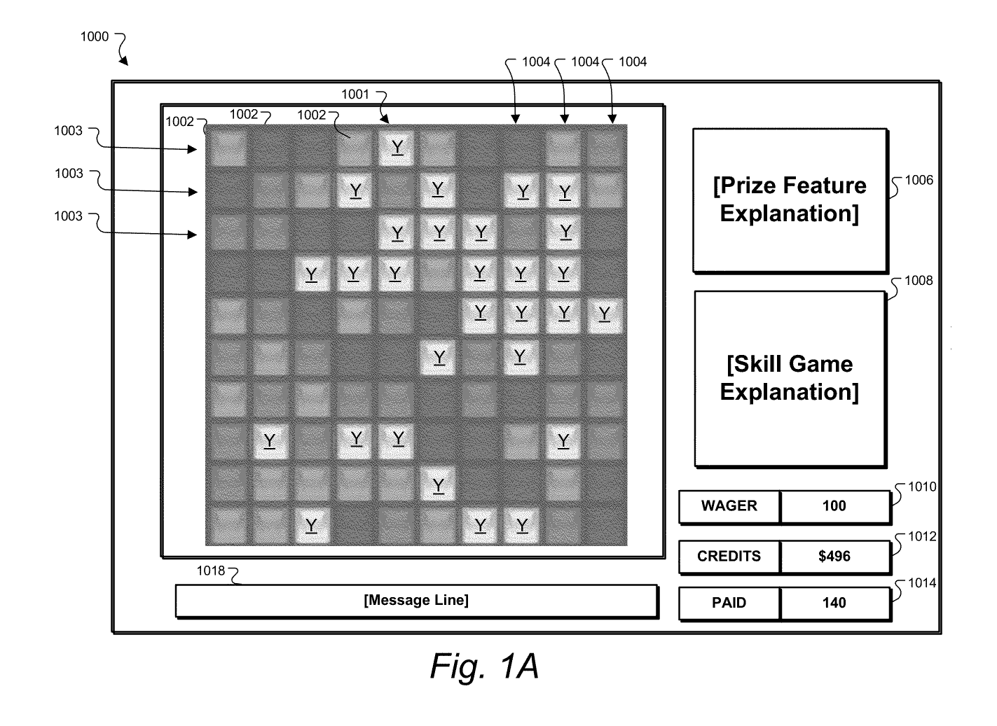

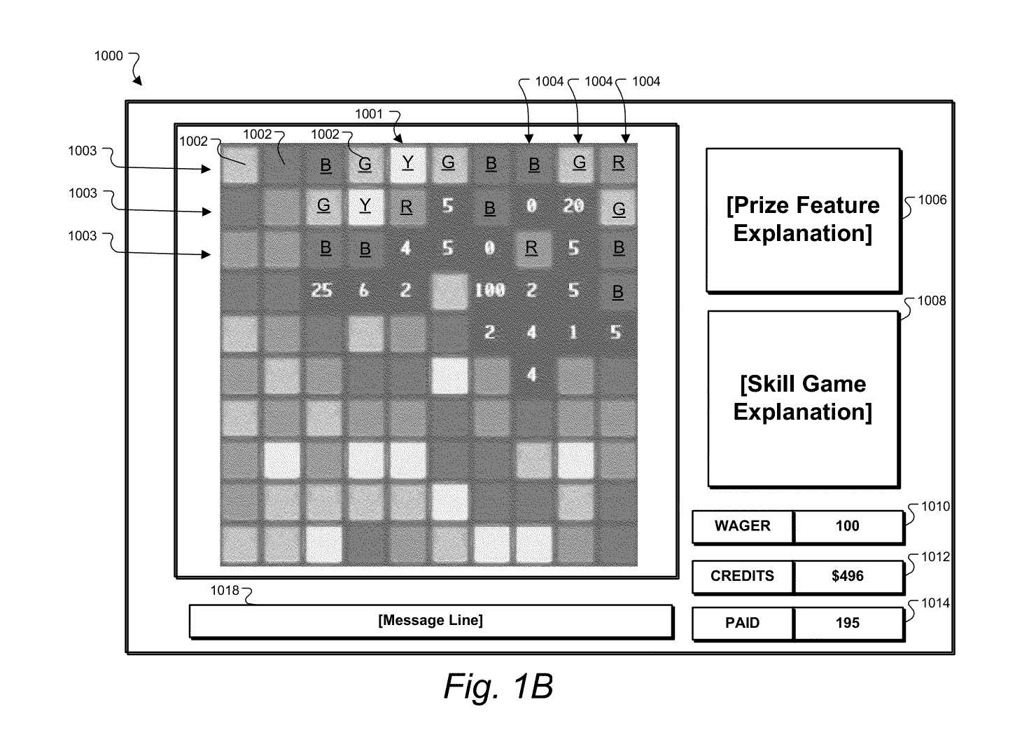

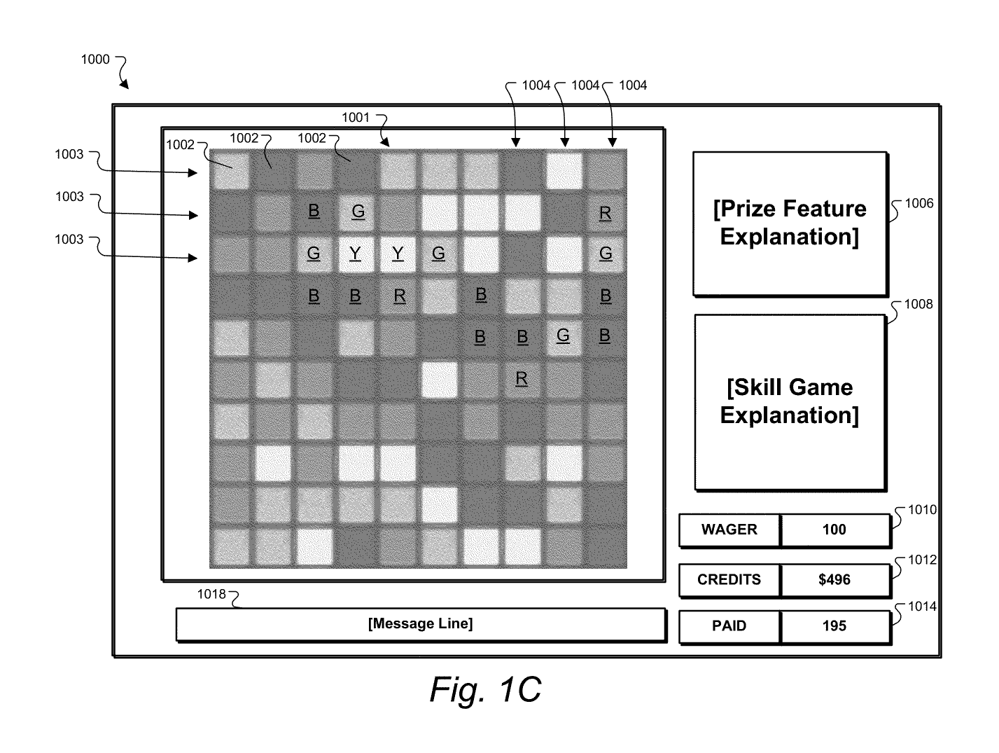

FIGS. 1A-1C show an example series of game screen diagrams according to a preferred embodiment in which a jumble skill game is presented to the player.

FIG. 1A shows an example game screen diagram 1000, which may be displayed at various gaming machines in a networked system. In this embodiment, the graphics display includes a field or grid 1001 of symbol locations that each display a gamepiece or gaming symbol 1002. It may be understood that the depicted grid 1001 is one version of a game play area for a game of skill, and other versions may, of course, employ other games of skill besides the jumble selection game described. In the depicted version, field 1001 comprises a grid of rows 1003 and columns 1004, including colored gamepieces which are to be strategically selected by the player in order to play the game of skill in this embodiment, as further described below. The game screen 1000 also includes a prize feature explanation box 1006 for displaying texts regarding prize features. The display may also include a skill game explanation area 1008, which is employed to display rules or playing hints as to how to play the current phase of the game of skill presented in the game play area. This area may be used to prompt the player that a game play is required to make a wager, or remind the player when the next game play entered will automatically produce a wager. A group of accounting indicators at the lower right displays various pieces of data such as the current wager box 1010, available credits 1012, and/or payouts 1014. Some embodiments may employ a “Play” or wager button on the screen, but preferred versions activate wagers automatically in response to game play inputs in the game play area. A message line 1018 displays messages concerning game progress, results, and related information.

In the game shown, the players make moves to eliminate matching groups of gamepieces, and are then awarded with a prize drawn from the prize pool that corresponds to the size of the group that they just eliminated. The larger the group, the greater the expected value of their prize. Part of the distribution of each prize pool may include bonus games. In one variation, certain valued prize distributions may guarantee particular bonus games.

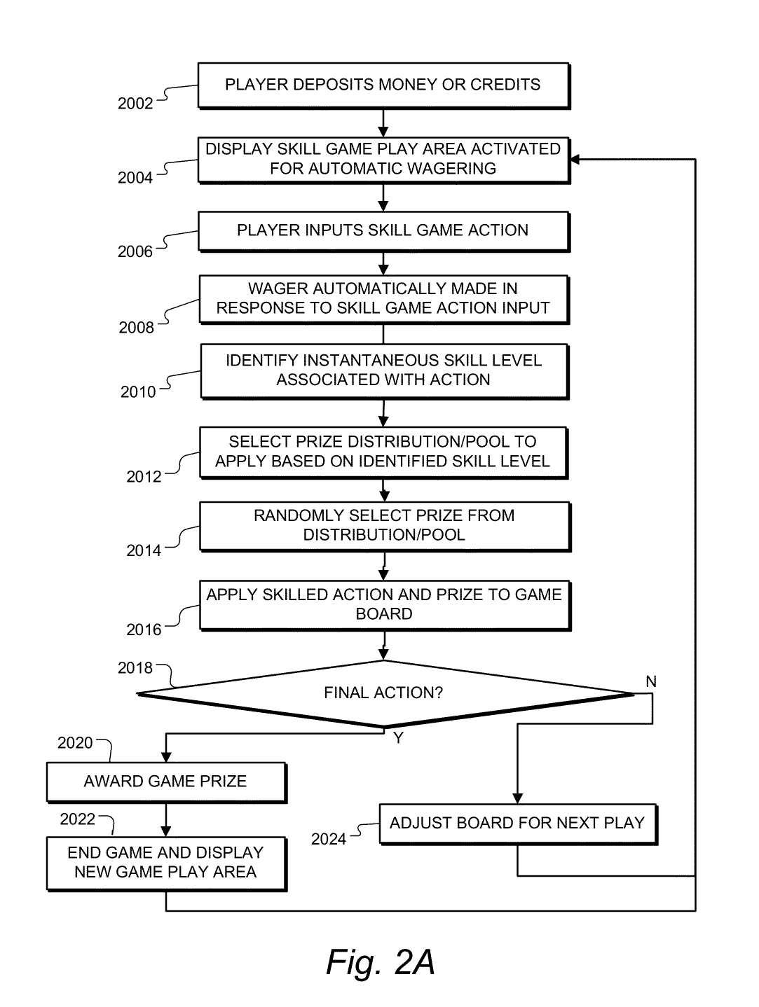

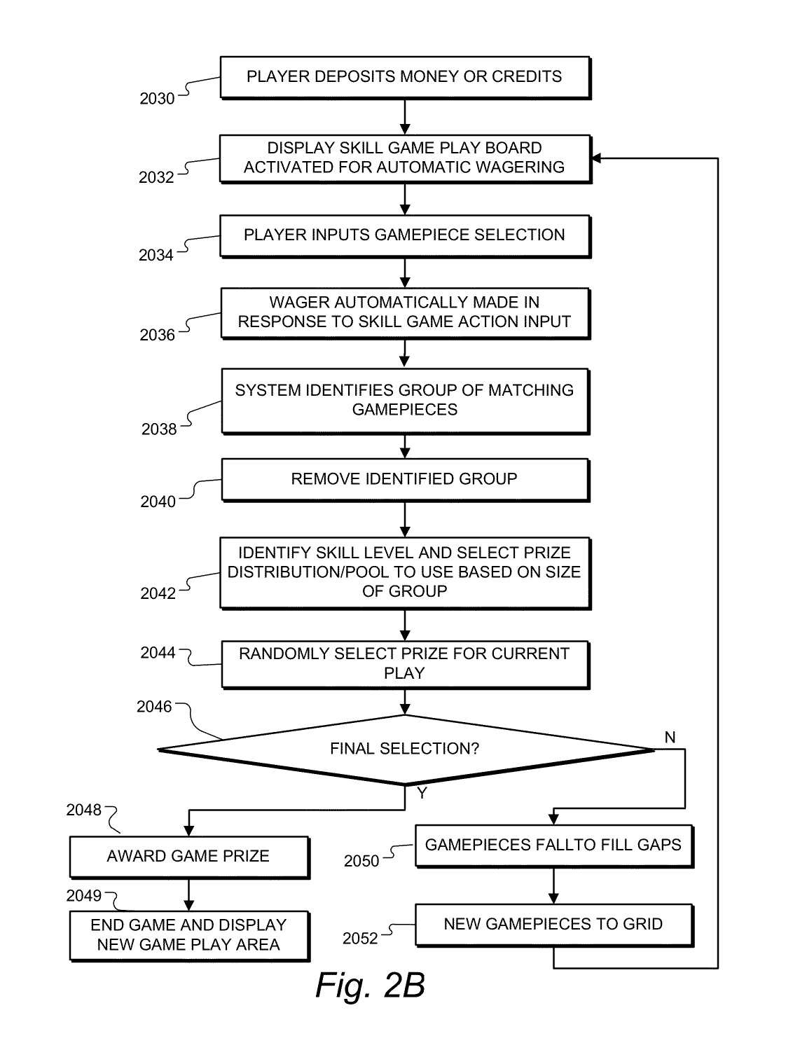

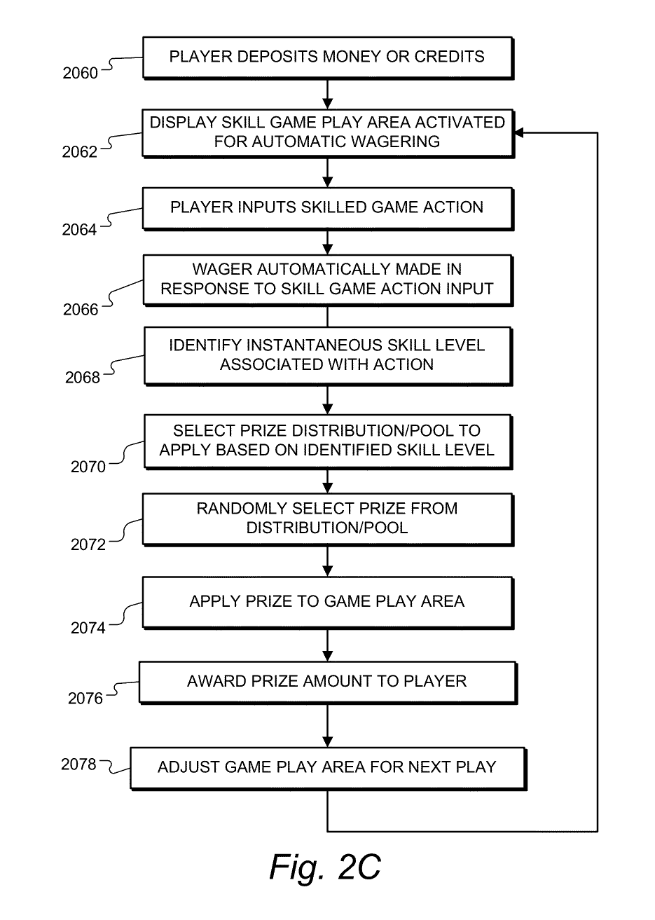

As depicted, the state of the skilled game play area 1001 includes various gamepieces 1002 that, in this embodiment, appear as colored jewels that may be green, blue, yellow, or red. The jewels are used as coded objects in a skilled matching game in which the player eliminates groups of coded objects from the grid. The code may be different colors, shapes, letters or other designations. In the depicted preferred game, objects are said to be in the same group if both objects match in color, and it is possible to trace a path from one object to the other only passing over matching objects. The preferred game uses a path that only involves moving to adjacent objects in the vertical or horizontal directions. The player interacts with the board by selecting an object, which in turn identifies and selects all objects that are in the same group as the selected object. All objects in that group are then removed from the board, and the immediate skill level associated with choosing the group is used by the game process in selecting a payout distribution used to award a prize for the move (see FIG. 2B and its description for more discussion of this process).

The example sequence from FIG. 1A to FIG. 1B includes a player selecting a group of yellow gamepieces. The selection causes a sequence of events that awards a prize, shows a graphic sequence of the prize integrated into the game play presentations, and then alters the game play grid to a new state for play as shown in FIG. 1B and then FIG. 1C. All of the yellow gamepieces are marked with a ‘Y’ in FIG. 1A. The group selected by the player in this example is a large group of contiguous yellow gamepieces in the upper half of the depicted game play area. Selection of this group constitutes a player “move” or “play”, and has a chance at winning a prize as further described below with regard to FIG. 2B. As shown in FIG. 1B, a prize has been selected and awarded for the play, and the selected group has disappeared and has been replaced by empty spaces which, in this embodiment, show point values that are assigned to each space by splitting up the prize awarded for the move. In this manner, the prize is integrated into the presentation of the game of skill.

FIG. 1C is a game screen diagram following that of FIG. 1B, and shows how the results of the player move change the game play grid. Objects above the now empty spaces move into the void created by the removed group, preferably by falling downward. The objects that fall in this example sequence are labeled with letters indicating their colors in this example game using colored jewel gamepieces. Then, new objects are created to fill in where there is empty space at the top of the grid. As can be seen in FIG. 1C, the empty spaces with credit values have been replaced by the colored gamepieces that were above them (each labeled gamepiece has fallen into a blank space). Next, new gamepieces have appeared in the spaces above the fallen gamepieces to fill in the gaps. At this point, the game is ready for another skilled move from the player, which may automatically create another wager in some embodiments, or may be made for free if the original wager entitles the player to more than one skilled move in the game. FIG. 2B discusses this process in more detail.

FIG. 2A is a flowchart of a process for providing a wager-per-play skill game according to another embodiment. The process begins at step 2002, where the system receives a deposit of cash or gaming credits from a player at a gaming terminal. The input activates the game, putting it in a state where moves or game play interactions entered in a game of skill will automatically activate a wager, as further described below. Next, at step 2004, the game terminal displays on its electronic display the skilled game play board or play area on which the player will play the game of skill on which they will wager. While a grid with selection options as skilled plays has been described, this is not limiting, and many games of skill may be structured in a manner such that they can be used with the present invention, including games that, instead of a game board, use a game play area allowing some other type of interactions such as targeting graphic items in the game play area, navigating or moving a gamepiece or avatar, aiming a projectile or bowling ball, or tipping over a domino to knock down a row of dominoes in a chain reaction, for example. While the particular game is not important, step 2004 displays to the player a game of skill in a position or state in which the player can make a move, or make a skilled action in the game. In preferred versions, the game play area at this step is active such that it is able to automatically enter wagers based on a skilled game play input. That is, the game software is connected or authorized to the player's current account in a way allowing a wager to be made in the same step and in response to entering a skilled game play input. The skilled game play input will, of course, be of a suitable nature for the particular game displayed. For example, the game may be a game in which players take turns, and this step may present a game board in which it is clearly the player's choice to act on the game board, or may present a single player game skill. At step 2006, the player is prompted to make a move, and the player considers their strategic position or status in the game, and which skilled play to enter. Once the player has chosen which move for skilled play to make, they input this as directed or prompted on the game screen instructions.

In response to receiving the skill game input, at step 2008, the process automatically makes a wager out of the player's credits. This wager entitles the player to a potential credit prize based on a “move” or “turn” outcome for this particular play, as further described below. In some embodiments, a single game input may entitle the player to multiple moves or player interactions on the game board or game play area. In such case, the game screen will make this clear in the skill game explanation area 1008 (FIG. 1A), and will, of course, skip the step of automatically entering a wager at step 2008 until a wager is required to continue playing the skill game. In this manner, the player may continue to play a skilled game seamlessly, without having to stop interacting with the game area to enter a separate wager input to activate their wager.

The process next takes this skilled game action chosen by the player and identifies an immediate skill level associated or derived from that particular action. That is, the process identifies an immediate skill level for the action the player just took. This skill level may be derived, calculated, looked up, or otherwise determined in a variety of ways. What is important, is that the game is of a type in which all of the possible moves that can be made by the player can be ranked by their relative skill and a skill level assigned for each move. Preferably, this skill level is determined independently of any player history and other data regarding the player's game play. While some games according to different embodiments may produce the skill level used at this step using current and historical skill data, taking into account the players past skilled moves, in preferred embodiments only the skill involved in making the present move is taken into account. This is referred to as an immediate skill level. In the jumble embodiment described herein using colored jewels, the immediate skill level is determined simply by counting the size of the group of jewels that was eliminated. For each move, an immediate skill level can be easily identified because the greater skill at that step is given to the move that eliminates the most jewels. Notice that an immediate skill level assigned at step 2010 may not necessarily be consistent with the player's overall skill level at which they played the game or achieve success in the game. For example, in the jumble game previously discussed, the player might make a lower value move at any particular round, in order to position certain jewels to form a larger group that may be eliminated in a subsequent round and thereby increase their overall win. In such a scenario, the player's obviously high skill level would be accounted for by the even greater immediate skill level assigned to those moves in which a large group of jewels was eliminated.

Such strategies may also be provided in other game versions. Another type of game that may be used is a physics object interaction game. Examples of such a game include casual online/mobile games built around knocking certain objects down with a projectile. The opportunity for player strategy may be made by arrangement of the objects to be knocked down. For example, a bowling alley game could be provided having a non-standard pin arrangement requiring the player to choose which pins to go for, or a projectile knocking down stacks of things like the classic milk jug carnival game. The pins or other objects to be knocked down are arranged in ranks and groups allowing the player's move to alter the future potential moves by opening a path through the ranks to larger groups (that is, choosing to knock down a smaller group to get to a bigger group behind it in the next turn). Such a feature may be employed in any physics based game in ways such as a player choosing to knock something small (of low value) down rather than something of mid-level value in order to have access to something larger in later turns.

Another game that may be used for the skill game in the present invention is a domino game. In one such game, the player is presented with a partially setup domino layout. The dominoes are arranged standing on end such that knocking down one, would knock down several others, but not all of them. Each skilled play input from the player selects a domino to knock over, which topples a group of dominoes, or to place a domino in a gap. The immediate skill level is measured by how many dominoes are knocked down for that turn. The skill would be in deciding when to try to add dominoes in order to connect groups, and when to knock them down.

In other embodiments, other methods may be applied to identify the immediate skill level associated with the player action. For example, some amount of territories, prizes, enemies eliminated, position gained, or other indicator may be used to calculate an immediate skill level associated with the action taken. In other embodiments, a game board may simply be designed in which each possible move is assigned a skill level in advance, the skill levels being stored in the appropriate data structure and looked up by the gaming process when each move is made in order to identify the skill level. What is important is first that skill is involved in the game, it is not just luck as in many common slot machine games, and second preferably that some analysis, looking up, or calculation is employed to identify a particular skill level that is associated with a single play made by the player.

There are various ways that the skill level of each player's turn may be evaluated in different versions of the invention, which may be selected based on what is feasible for the particular game. For example, each turn may be evaluated based on a comparison to the ideal play that could have been made at that turn. Or, each turn may be evaluated based on calculating a probability that the move will lead to victory. Next, at step 2012, the process uses the immediate skill level to select a prize distribution or prize pool to be employed in fulfilling the player's current wager. A prize distribution is used as the term is commonly understood in the art to mean a designated pay table or set of prizes with their associated probabilities mapped to some random events such as a single random number generation. A prize pool, in this context, means a group of predetermined prizes that are distributed in a desired way so that prizes are chosen either in order from the group or chosen randomly from the group, to achieve a desired prize distribution similar to the effect of a pay table. The distinction is commonly recognized to be that a prize pool contains predetermined electronic records of prizes that are simply pulled and eliminated from the pool while the pay table or prize distribution generates the prizes according to a designated random process. Typically prize pools or distributions will not be mixed within a particular game, so that at step 2012 any particular embodiment will usually select from among multiple available prize distributions, or from among available prize pools. However, some particular high-value prizes, unique prizes, bonus prizes, or jackpot prizes may be stored in a pool, while ordinary game prizes are provided through a distribution/paytable. Therefore it is possible that step 2012 may select from among multiple different methods of providing a prize. What is important is that there are several different distributions of prizes that are available, either through pay tables or through pools, and at step 2012, the process uses the identified immediate skill level to select one of these. Preferably, prize distributions with a relatively higher expected payout are chosen for relatively higher identified skill levels.

Next, at step 2014, the process employs the prize distribution or pool that was chosen in order to provide a prize for the current game play action. Note that prizes may be conglomerated when a single player wager entitles them to multiple plays or game play actions of the game, or a single prize may be provided for each single player wager made, depending upon the particular embodiment and methods employed. At step 2014, preferably a random number is generated or a random outcome is selected from a pool according to known methods in the slot machine industry. It may be understood that as used herein the word random includes the pseudo-random software algorithms employed to create randomly distributed numbers as used in the gaming industry.

Next, at step 2016, the process applies the skilled action and the prize to the game (if needed), for example by displaying movement, interaction, or exchanges or other action made in the game as a result of the skill game action taken by the player. This step may not always involve applying the prize in the game, because not all embodiments will provide any consequence in the prize awarded in the display or status of the actual skill game play board. In the example described above, the prize amount was shown assigned in pieces to multiple locations on the skill game play board (FIG. 2B), and then the remaining sequence of applying the skilled action to the game play board was shown by other jewels dropping into place to fill the blank locations, and new jewels filling in the empty spaces. This is, of course, not limiting and other embodiments will apply the skilled action in the game according to the rules of the particular skilled game being played. Further, other embodiments may provide other methods to integrate the prizes awarded into the display of the skilled game play board, in order to make the skilled game more engaging, entertaining, and to help reflect the direct result of the player's skilled action in the game display as well as connecting that action mentally for the player to the credits awarded as a result of their play. While a preferred embodiment employs some method of integrating the prize awarded as a result of the player's skilled game action to the skilled game play board, this is not limiting and other embodiments may not have such integration. Further, the integration may be achieved by other means that display prize credit numbers, either partially or fractionally as in the example above, somewhere in the skilled game play board. For example, a graphic change may be applied to certain game elements or gamepieces such as changing their size, color, or upgrading gamepieces by changing the nature of the gamepiece to something having a recognizable higher value in the context of the current game.

Next, at step 2018, if the last game action made by the player is the final action allowed in the context of the current game play area or game board (that is, if the skill game is the type of game that can be won, or a round clearly completed), the process goes to step 2020, where it awards any prize due to the player for completing the game and then ends the game at step 2022 and displays a fresh new game play area. Back at step 2018, if more skilled game play actions are allowed, the process will go back to displaying the game play board at step 2004 to allow more skilled game actions by the player until the skill game is completed. Some versions may feature skill games that may be played continuously by simply preserving the state of the game board such that it persists at step 2024 and allows the player to continue making skilled moves.

FIG. 2B is a flowchart of a process for conducting a wager-per-play skill game according to another embodiment. In this embodiment, a skill game such as that shown in FIGS. 1A-C is used. With reference now to FIG. 2B, as well as FIGS. 1A-C, the process begins at step 2030 when it receives a player deposit of money or credits. Next, at step 2032, the process displays a grid of gamepieces such as a grid in the state shown in FIG. 1A. Preferably, the grid of gamepieces at this step is active such that it is able to automatically enter wagers based on a skilled game play input. That is, the game software is connected or authorized to the player's current account in a manner allowing a wager to be made in the same step as, and in response to, entering a skilled game play input. The player is allowed to consider this grid to determine the best skilled move and then enter their selection at step 2034 by touching on the touchscreen display a gamepiece to identify the group the player desires to eliminate in their current play.

In response to receiving the skill game input, at step 2036, the process automatically makes a wager out of the player's credits. This wager entitles the player to a potential credit prize based on a “move” or “turn” outcome for this particular play. Other versions of this game may also provide for multiple selections following a first selection with an automatic wager. For example, the game may prompt a player that the next move will automatically enter a wager entitled to three total moves. In such case, step 2036 would be skipped for the next two moves, but then the step would be used again for the fourth move.

Next at step 2038, the system applies the game rules to identify the entire related group of matching gamepieces, which are then eliminated at step 2040. For example, this step was performed on the group of yellow gamepieces that was eliminated as shown in FIG. 1B.

Next, at step 2042, the process identifies the immediate skill level associated with the skilled play by the player. Using this, the process selects the prize distribution or prize pool based on the immediate skill level of the skilled game action made by the player, in this version the skill level being identified simply by counting the size of the group of eliminated jewels. As shown in the example FIG. 1B, the group size in this example is 18, which represents a higher skill level than say a group of 15 jewels eliminated a single move, and is therefore assigned a designated skill level associated with the group size of 18.

After selecting the prize distribution to be used, the process goes to step 2044 where it randomly selects a prize for the current play according to the distribution selected in the previous step. The prize is then awarded, and may be integrated into the game presentation as previously described, for example by assigning credit values to each gamepiece eliminated.

If this is the final play allowed on the current game board, the process at 2046 branches to step 2048 where it awards any prize that may be given for completing the game board. The process then goes to step 2049 where it ends the game and displays a fresh new game play area.

If back at step 2046, the player is allowed to continue play on the current game board, the process branches instead to step 2050 where the skill game continues in the display area and more gamepieces fall to fill in the gaps created by the eliminated group, with new cases appearing at step 2052, such as the relocated pieces and new pieces shown in the example game sequence in FIG. 1C. Next the process go back to step 2032, where the state achieved at step 2052 is displayed as the current game state with which the player can interact by inputting another skilled game play at step 2036.

FIG. 2C is a flowchart of a process for providing a wager-per-play skill game according to another embodiment. This embodiment provides a game which can be continuously played by entering skill game inputs to automatically activate wagers, where the state of the skilled game play area and therefore the game state in general persists between wagers. This allows the player to apply a strategy across multiple plays to try to improve their strategic position in the game and thereby achieve more valuable skilled actions in the game, which lead to a higher identified immediate skill level and therefore generally higher prizes. The process is similar to that described with respect to FIG. 2A except the flowchart is simplified in that it does not provide an option for completing a round or game board. Instead, this version provides continuous play in which each wager created at step 2066 leads to a single prize randomly selected from the appropriate pool at step 2072, and awards it to the player at step 2076.

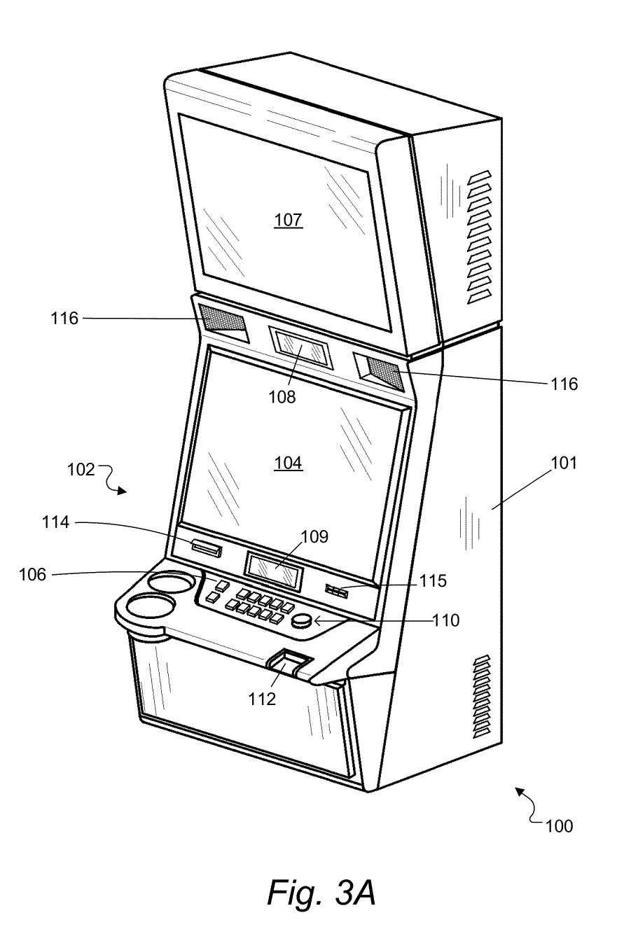

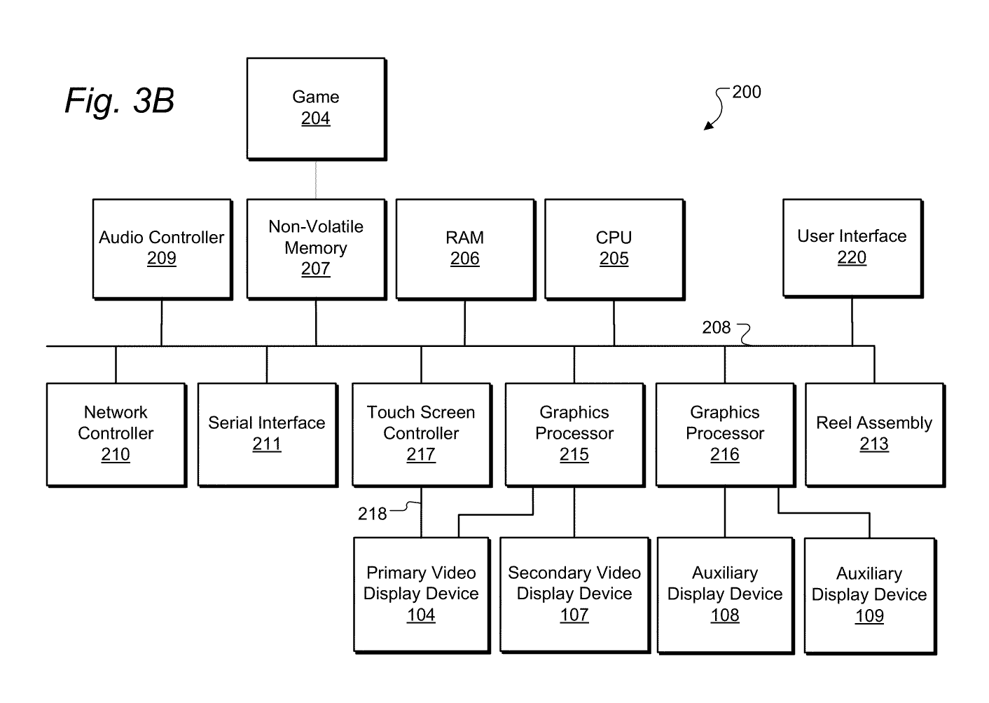

FIG. 3A shows a gaming machine 100 that may be used to implement a wager-per-play skill game according to the present invention. The block diagram of FIG. 3B shows further details of gaming machine 100. Referring to FIG. 3A, gaming machine 100 includes a cabinet 101 having a front side generally shown at reference numeral 102. A primary video display device 104 is mounted in a central portion of the front surface 102, with a ledge 106 positioned below the primary video display device and projecting forwardly from the plane of the primary video display device. In addition to primary video display device 104, the illustrated gaming machine 100 includes a secondary video display device 107 positioned above the primary video display device. Gaming machine 100 also includes two additional smaller auxiliary display devices, an upper auxiliary display device 108 and a lower auxiliary display device 109. It should also be noted that each display device referenced herein may include any suitable display device including a cathode ray tube, liquid crystal display, plasma display, LED display, or any other type of display device currently known or that may be developed in the future.

In preferred versions, the gaming machine 100 illustrated in FIG. 3A also includes a number of mechanical control buttons 110 mounted on ledge 106. These control buttons 110 may allow a player to select a bet level, select pay lines if a pay line game is offered on the machine, select a type of game or game feature, and actually start a play in a primary game. Other forms of gaming machines according to the invention may include switches, joysticks, or other mechanical input devices, and/or virtual buttons and other controls implemented on a suitable touch screen video display to allow the player to participate in the wager-per-play games presented through machine 100. For example, primary video display device 104 in gaming machine 100 provides a convenient display device for implementing touch screen controls.

It will be appreciated that gaming machines may also include a number of other player interface devices in addition to devices that are considered player controls for use in playing a particular game. Gaming machine 100 also includes a currency/voucher acceptor having an input ramp 112, a player card reader having a player card input 114, and a voucher/receipt printer having a voucher/receipt output 115. Audio speakers 116 generate an audio output to enhance the user's playing experience. Numerous other types of devices may be included in gaming machines that may be used according to the present invention.

FIG. 3B shows a logical and hardware block diagram 200 of gaming machine 100 which includes a central processing unit (CPU) 205 along with random access memory 206 and nonvolatile memory or storage device 207. All of these devices are connected on a system bus 208 with an audio interface device 209, a network controller 210, and a serial interface 211. A graphics processor 215 is also connected on bus 208 and is connected to drive primary video display device 104 and secondary video display device 107 (both mounted on cabinet 101 as shown in FIG. 3A). A second graphics processor 216 is also connected on bus 208 in this example to drive the auxiliary display devices 108 and 109 also shown in FIG. 3A. As shown in FIG. 3B, gaming machine 100 also includes a touch screen controller 217 connected to system bus 208. Touch screen controller 217 is also connected via signal path 218 to receive signals from a touch screen element associated with primary video display device 104. It will be appreciated that the touch screen element itself typically comprises a thin film that is secured over the display surface of primary video display device 104. The touch screen element itself is not illustrated or referenced separately in the figures.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 3B are elements commonly associated with a personal computer. These elements are preferably mounted on a standard personal computer chassis and housed in a standard personal computer housing which is itself mounted in cabinet 101 shown in FIG. 3A. Alternatively, the various electronic components may be mounted on one or more circuit boards housed within cabinet 101 without a separate enclosure such as those found in personal computers. Those familiar with data processing systems and the various data processing elements shown in FIG. 3B will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 3B as being connected directly on system bus 208 may in fact communicate with the other system components through a suitable expansion bus. Audio interface 209, for example, may be connected to the system via a PCI bus. System bus 208 is shown in FIG. 3B merely to indicate that the various components are connected in some fashion for communication with CPU 205 and is not intended to limit the invention to any particular bus architecture. Numerous other variations in the gaming machine internal structure and system may be used without departing from the principles of the present invention.

It will also be appreciated that graphics processors are also commonly a part of modern computer systems. Although separate graphics processor 215 is shown for controlling primary video display device 104, secondary video display device 107, and graphics processor 216 is shown for controlling both auxiliary display devices 108 and 109, it will be appreciated that CPU 205 may control all of the display devices directly without any intermediate graphics processor. The invention is not limited to any particular arrangement of processing devices for controlling the video display devices included with gaming machine 100. Also, a gaming machine implementing the present invention is not limited to any particular number of video display devices or other types of display devices.

In the illustrated gaming machine 100, CPU 205 executes software which ultimately controls the entire gaming machine including the receipt of player inputs and the presentation of the graphic symbols displayed according to the invention through the display devices 104, 107, 108, and 109 associated with the gaming machine. As will be discussed further below, CPU 205 either alone or in combination with graphics processor 215 may implement a presentation controller for performing functions associated with a primary game that may be available through the gaming machine and may also implement a game client for directing one or more display devices at the gaming machine to display portions of a wager-per-play skill game according to the present invention. CPU 205 also executes software related to communications handled through network controller 210, and software related to various peripheral devices such as those connected to the system through audio interface 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 may comprise a hard drive or other mass storage device providing storage for programs not in use or for other data generated or used in the course of gaming machine operation. Network controller 210 provides an interface to other components of a gaming system in which gaming machine 100 is included. In particular, network controller 210 provides an interface to a game controller which controls certain aspects of the wager-per-play skill game as will be discussed below in connection with FIGS. 3A-B.

It should be noted that the invention is not limited to gaming machines employing the personal computer-type arrangement of processing devices and interfaces shown in example gaming machine 100. Other gaming machines through which a wager-per-play skill game is implemented may include one or more special purpose processing devices to perform the various processing steps for implementing the present invention. Unlike general purpose processing devices such as CPU 205, these special purpose processing devices may not employ operational program code to direct the various processing steps.

It should also be noted that the invention is not limited to gaming machines including only video display devices for conveying results. It is possible to implement a wager-per-play skill game within the scope of the present invention using an electro mechanical arrangement or even a purely mechanical arrangement for displaying the symbols needed to complete the wager-per-play skill game as described herein. For example, a gaming machine suitable for providing a wager-per-play skill game may include a mechanical reel-type display rather than a video-type display device for displaying results in a primary game, and include a video display device for presenting the wager-per-play skill game as a bonus game.

Still referring to the hardware and logical block diagram 200 showing an example design for a gaming machine 100, the depicted machine in operation is controlled generally by CPU 205 which stores operating programs and data in memory 207 with wagering game 204, user interface 220, network controller 210, audio/visual controllers, and reel assembly 213 (if a mechanical reel configuration). CPU or game processor 205 may comprise a conventional microprocessor, such as an Intel Pentium microprocessor, mounted on a printed circuit board with supporting ports, drivers, memory, software, and firmware to communicate with and control gaming machine operations, such as through the execution of coding stored in memory 207 including one or more wagering games 204. Game processor 205 connects to user interface 220 such that a player may enter input information and game processor 205 may respond according to its programming, such as to apply a wager and initiate execution of a game.

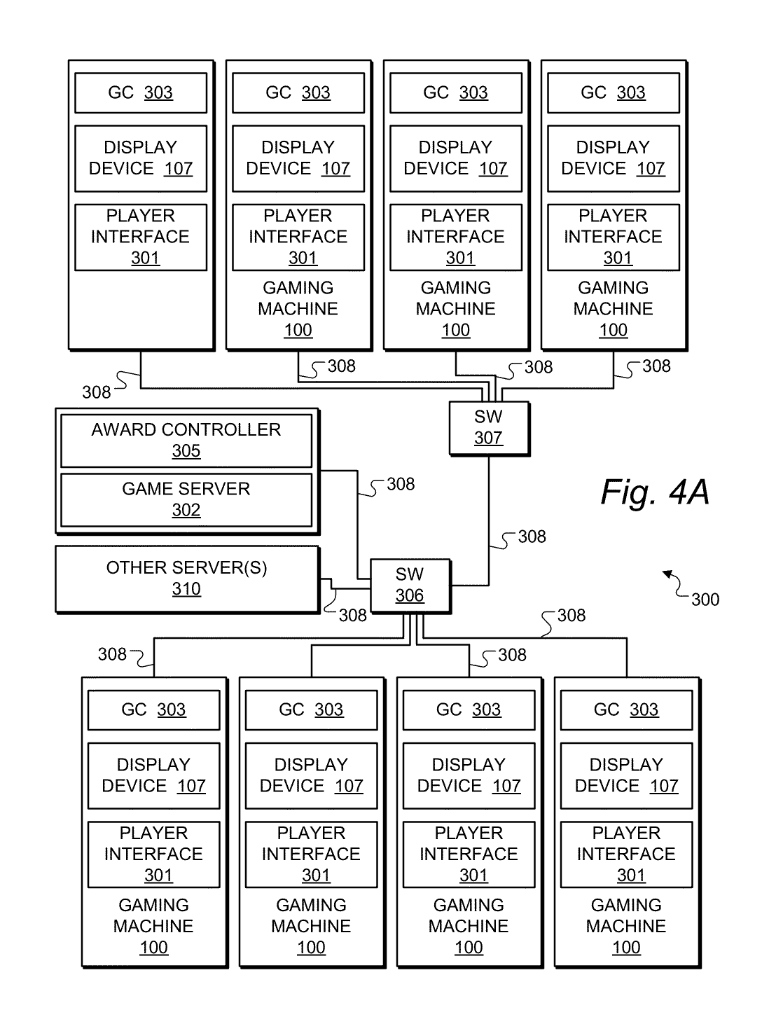

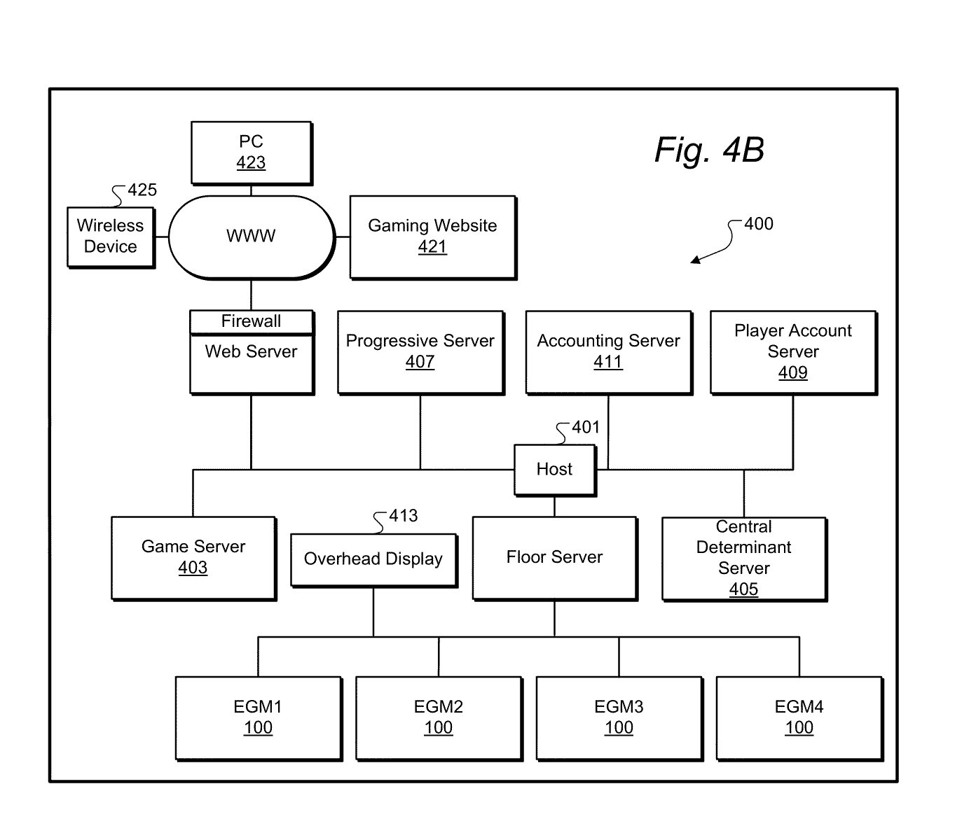

Game processor 205 also may connect through network controller 210 to a gaming network, such as example casino server network 400 shown in FIG. 4B. Referring now to FIG. 4B, the casino server network 400 may be implemented over one or more site locations and include host server 401, remote game play server 403 (which may be configured to provide game processor functionality including determining game outcomes and providing audio/visual instructions to a remote gaming device), central determination server 405 (which may be configured to determine lottery, bingo, or other centrally determined game outcomes and provide the information to networked gaming machines 100 providing lottery and bingo-based wagering games to patrons), progressive server 407 (which may be configured to accumulate a progressive pool from a portion of wagering proceeds or operator marketing funds and to award progressive awards upon the occurrence of a progressive award winning event to one or more networked gaming machines 100), player account server 409 (which may be configured to collect and store player information and/or awards and to provide player information to gaming machines 100 after receiving player identification information such as from a player card), and accounting server 411 (which may be configured to receive and store data from networked gaming machines 100 and to use the data to provide reports and analyses to an operator). Through its network connection, gaming machine 100 may be monitored by an operator through one or more servers such as to assure proper operation, and, data and information may be shared between gaming machine 100 and a respective one of the servers in the network such as to accumulate or provide player promotional value, to provide server-based games, or to pay server-based awards.

Referring now to FIG. 4A, a gaming system 300 according to another embodiment of the present invention is shown again in a network and system diagram format. System 300 includes a number of gaming machines, each comprising a gaming machine 100 in this example implementation. For purposes of describing system 300, each gaming machine 100 in FIG. 4A is shown as including a video display device 107 and a player interface that may include buttons, switches, or other physical controls and/or touch screen controls as discussed above in connection with FIG. 4A. This player interface is labeled 301 in FIG. 4A. System 300 further includes a game server 302 and a respective game client 303 (abbreviated “GC” in FIG. 4A) included with each respective gaming machine 100. In the form of the invention shown in FIG. 4A these two components, game server 302 and the game client components 303 combine to implement a game control arrangement which will be described in detail below. System 300 also includes an award controller 305, which is shown in FIG. 4A as being associated with game server 302 to indicate that the two components may be implemented through a common data processing device/computer system. Gaming machines 100, game server 302, and award controller 305 are connected in a network communication arrangement including first and second network switches 306 and 307, connected together through various wired or wireless signal paths, all shown as communications links 308 in FIG. 4A.

Each gaming machine 100, and particularly player interface 301 associated with each gaming machine, allows a player to make any inputs that may be required to make the respective gaming machine eligible for a wager-per-play skill game, and make selections of any selectable objects displayed at the respective gaming machine in the course of the wager-per-play skill game. Player interface 301 also allows a player at the gaming machine to initiate plays in a primary game available through the gaming machine in some implementations. The respective video display device 107 associated with each respective gaming machine 100 is used according to the invention to generate the graphic displays to show the various elements of a wager-per-play skill game at the respective gaming machine.

The game control arrangement made up of game server 302 and the respective game client 303 at a given gaming machine functions to control the respective video display device 107 for that gaming machine to display the wager-per-play skill game and the user interface elements thereof. Award controller 305 is responsible for awarding prizes for a player's participation in a wager-per-play skill game, and maintaining progressive prize information where the wager-per-play skill game offers one or more progressive prizes. The network arrangement made up of network switches 306 and 307, and the various communication links 308 shown in FIG. 4A is illustrated merely as an example of a suitable communications arrangement. It should be noted that the game control arrangement, or as it is referred to generally the “game controller,” may be implemented in some embodiments entirely on the gaming machine. This is especially true in jurisdictions that allow Class III gaming conducted with random number generators at each gaming machine. The present invention is not limited to any particular communications arrangement for facilitating communications between game server 302 and various gaming machines 100. Any wired or wireless communication arrangement employing any suitable communications protocols (such as TCP/IP for example) may be used in an apparatus according to the invention.

FIG. 4A shows other server(s) 310 included in the network. This illustrated “other server(s)” element 310 may include one or more data processing devices for performing various functions related to games conducted through system 300 and any other games that may be available to players through gaming machines 100. For example, apparatus 300 may be accounting servers providing support for cashless gaming or various forms of mixed cash/cashless gaming through the various gaming machines 100. In this example, an additional one of the other servers 310 will be included in apparatus 300 for supporting these types of wagering and payout systems. As another example, the various gaming machines 100 included in system 300 may allow players to participate in a game (primary game) other than the wager-per-play skill game described herein, and this other game may rely on a result identified at or in cooperation with a device that is remote from the gaming machines. In this example, another server 310 may be included in the system for identifying results for the primary game and communicating those results to the various gaming machines 100 as necessary. Generally, the other server(s) 310 shown in FIG. 4A are shown only to indicate that numerous other components may be included along with the elements that participate in providing wager-per-play skill games according to the present invention. Other server(s) 310 may provide record keeping, player tracking, accounting, result identifying services, or any other services that may be useful or necessary in a gaming system.

Referring to FIG. 4B, a block diagram of another example networked gaming system 400 associated with one or more internet-connected gaming facilities is shown, including one or more networked gaming machines 100 in accordance with one or more embodiments. With reference to FIG. 4B, while a few servers have been shown separately, they may be combined or split into additional servers having additional capabilities.

As shown, networked gaming machines 100 (EGM1-EGM4) and one or more overhead displays 413 may be network connected and enable the content of one or more displays of gaming machines 100 to be mirrored or replayed on an overhead display. For example, the primary display content may be stored by the display controller or game processor 205 and transmitted through network controller 210 to the overhead display controller either substantially simultaneously or at a subsequent time according to either periodic programming executed by game processor 205 or a triggering event, such as a jackpot or large win, at a respective gaming machine 100. In the event that gaming machines 100 have cameras installed, the respective player's video images may be displayed on overhead display 413 along with the content of the player's display 100 and any associated audio feed.

In one or more embodiments, game server 403 may provide server-based games and/or game services to network connected gaming devices, such as gaming machines 100 (which may be connected by network cable or wirelessly). Progressive server 407 may accumulate progressive awards by receiving defined amounts (such as a percentage of the wagers from eligible gaming devices or by receiving funding from marketing or casino funds) and provide progressive awards to winning gaming devices upon a progressive event, such as a progressive jackpot game outcome or other triggering event such as a random or pseudo-random win determination at a networked gaming device or server (such as to provide a large potential award to players playing the community feature game). Accounting server 411 may receive gaming data from each of the networked gaming devices, perform audit functions, and provide data for analysis programs, such as the IGT Mariposa program bundle.

Player account server 409 may maintain player account records, and store persistent player data such as accumulated player points and/or player preferences (e.g. game personalizing selections or options). For example, the player tracking display may be programmed to display a player menu that may include a choice of personalized gaming selections that may be applied to a gaming machine 100 being played by the player.

In one or more embodiments, the player menu may be programmed to display after a player inserts a player card into the card reader. When the card reader is inserted, an identification may be read from the card and transmitted to player account server 409. Player account server 409 transmits player information through network controller 210 to user interface 220 for display on the player tracking display. The player tracking display may provide a personalized welcome to the player, the player's current player points, and any additional personalized data. If the player has not previously made a selection, then this information may or may not be displayed. Once the player makes a personalizing selection, the information may be transmitted to game processor 205 for storing and use during the player's game play. Also, the player's selection may be transmitted to player account server 409 where it may be stored in association with the player's account for transmission to the player in future gaming sessions. The player may change selections at any time using the player tracking display (which may be touch sensitive or have player-selectable buttons associated with the various display selections).

In one or more embodiments, a gaming website may be accessible by players, e.g. gaming website 421, whereon one or more games may be displayed as described herein and played by a player such as through the use of personal computer 423 or handheld wireless device 425 (e.g. Blackberry cell phone, Apple iPhone, personal data assistant (PDA), iPad, etc.). To enter the website, a player may log in with a username (that may be associated with the player's account information stored on player account server 409 or be accessible by a casino operator to obtain player data and provide promotional offers), play various games on the website, make various personalizing selections, and save the information, so that during a next gaming session at a casino establishment, the player's playing data and personalized information may be associated with the player's account and accessible at the player's selected gaming machine 100.

Any use of ordinal terms such as “first,” “second,” “third,” etc., to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

Further, as described herein, the various features have been provided in the context of various described embodiments, but may be used in other embodiments. The combinations of features described herein should not be interpreted to be limiting, and the features herein may be used in any working combination or sub-combination according to the invention. This description should therefore be interpreted as providing written support, under U.S. patent law and any know relevant foreign patent laws, for any working combination or some sub-combination of the features herein.

The above described preferred embodiments are intended to illustrate the principles of the invention, but not to limit the scope of the invention. Various other embodiments and modifications to these preferred embodiments may be made by those skilled in the art without departing from the scope of the present invention.

1. A method of providing a wagering game, the method comprising:
(a) receiving a credit deposit input from a player and, in response, activating a gaming grid including a plurality of gamepieces displayed on an electronic display to receive player inputs and automatically create wagers from the player's credits;
(b) receiving player input selecting a gamepiece, the input involving player skill;
(c) in response to receiving the player input, activating a wager associated with the input, and further identifying a group of gamepieces related to the selected gamepiece;
(d) after (c), removing from the grid the identified group of gamepieces and replacing them with indicia indicating an empty space in the grid;
(e) based on the size of the group, selecting a first prize distribution from which a prize will be awarded forming at least part of a game prize responsive to the wager input; and
(f) randomly selecting a first prize from the first prize distribution.

2. The method of claim 1, further comprising after (d), displacing a plurality of the displayed gamepieces into at least some of the empty spaces, and moving a plurality of new gamepieces onto the grid to fill spaces left by the displaced gamepieces.

3. The method of claim 2, further comprising receiving a second player input selecting a second gamepiece, and in response activating a second wager associated with the second input selecting a second group of gamepieces related to the second gamepiece, and based on the size of the second group, selecting a second prize distribution from which a second prize will be awarded forming at least part of the game prize responsive to the wager input.

4. The method of claim 3 further causing a state of the gaming grid to persist after moving the plurality of new gamepieces onto the grid to allow the second player input to be made on the grid in a state produced by their first move.

5. The method of claim 1 in which the selecting a prize distribution further includes selecting a distribution with a relatively higher expected value of prize for a relatively larger group.

6. The method of claim 1 in which the group is identified by choosing all matching gamepieces on a contiguous path travelling horizontally and vertically in the grid from the selected gamepiece.

7. A method of providing a wagering game, the method comprising:
(a) receiving a credit deposit input from a player and, in response, activating a game play area for a game of skill on an electronic display to receive player inputs indicating skilled play actions and, in response, automatically create wagers from the player's credits;
(b) receiving player input indicating a skilled play action to be made in the game of skill and creating a wager associated with the input, and further causing a skilled play action to occur in the game of skill;
(c) identifying an immediate skill level from the skilled play action, and based on the immediate skill level selecting a prize distribution or prize pool from among multiple available prize distributions or prize pools; and
(d) randomly selecting a first prize from the prize distribution or pool to be awarded in response to the skilled play action.

8. The method of claim 7, further comprising maintaining a state of the game play area for use with another skilled play action.

9. The method of claim 8, further comprising:
(a) receiving a second player input indicating a second skilled play action to be made in the game of skill and further causing the second skilled play action to occur in the game of skill;
(b) identifying a second immediate skill level from the second skilled play action, and based on the second immediate skill level selecting a second prize distribution or prize pool from among the multiple available prize distributions or prize pools; and
(c) randomly selecting a second prize from the prize distribution or pool to be awarded in response to the second skilled play action.

10. The method of claim 9 in which identifying the immediate skill levels for the first and second skilled play actions is done by selecting from a set of skill levels defined for each possible skilled play action available to the player when making the first and second skilled play actions, respectively.

11. The method of claim 9 in which randomly selecting the first and second prizes is done in response to the wager created for the first skilled play action input.

12. The method of claim 7 further comprising:
(a) applying the skilled play action to the game play board and maintaining the state of the board for use with another skilled play action;
(b) next, receiving a second player input indicating a second skilled play action to be made in the game of skill and in response creating a wager associated with the second input, and further causing a skilled play action to occur in the game of skill;
(c) identifying a second immediate skill level from the second skilled play action, and based on the second immediate skill level selecting a second prize distribution or prize pool from among the multiple available prize distributions or prize pools; and
(d) randomly selecting a second prize from the prize distribution or pool to be awarded in response to the second skilled play action.

13. A computer program product embodied on one or more tangible non-transient computer readable media, the program product for running on one or more servers and one or more gaming terminals in a gaming network and comprising code executable for:
(a) receiving a credit deposit input from a player and, in response, activating a game play area for a game of skill on an electronic display to receive player inputs indicating skilled play actions and, in response, automatically create wagers from the player's credits;
(b) receiving player input indicating a skilled play action to be made in the game of skill and creating a wager associated with the input, and further causing a skilled play action to occur in the game of skill;
(c) identifying an immediate skill level from the skilled play action, and based on the immediate skill level selecting a prize distribution or prize pool from among multiple available prize distributions or prize pools; and
(d) randomly selecting a first prize from the prize distribution or pool to be awarded in response to the skilled play action.

14. The program product of claim 13, further comprising code executable for maintaining a state of the game play area for use with another skilled play action.

15. The program product of claim 14, further comprising code executable for:
(a) receiving a second player input indicating a second skilled play action to be made in the game of skill and further causing the second skilled play action to occur in the game of skill;
(b) identifying a second immediate skill level from the second skilled play action, and based on the second immediate skill level selecting a second prize distribution or prize pool from among the multiple available prize distributions or prize pools; and
(c) randomly selecting a second prize from the prize distribution or pool to be awarded in response to the second skilled play action.

16. The program product of claim 15 in which identifying the immediate skill levels for the first and second skilled play actions is done by selecting from a set of skill levels defined for each possible skilled play action available to the player when making the first and second skilled play actions, respectively.

17. The program product of claim 16 in which randomly selecting the first and second prizes is done in response to the wager created for the first skilled play action input.

18. The program product of claim 13, further comprising code executable for:
(a) applying the skilled play action to the game play board and maintaining the state of the board for use with another skilled play action;
(b) next, receiving a second player input indicating a second skilled play action to be made in the game of skill and in response creating a wager associated with the second input, and further causing the second skilled play action to occur in the game of skill;
(c) identifying a second immediate skill level from the second skilled play action, and based on the second immediate skill level selecting a second prize distribution or prize pool from among the multiple available prize distributions or prize pools; and
(d) randomly selecting a second prize from the prize distribution or pool to be awarded in response to the second skilled play action.
